(19) United States
(12) Patent Application Publication
(10) Pub. No.: US 2006/0100548 A1
(43) Pub. Date: May 11, 2006

(54) Ultrasonic implant revision instrument

(75) Inventor: Joe Ferguson, Collierville, TN (US)

Correspondence Address: HAYNES AND BOONE, LLP, 901 MAIN ST, SUITE 3100, DALLAS, TX, 75202, US

(73) Assignee: SDGI Holdings, Inc., Wilmington, DE (US)

(21) Appl. No.: 10/984,412

(22) Filed: Nov. 9, 2004

(51) Int. Cl. A61H 1/00

(52) U.S. Cl. 601/2

(57) ABSTRACT

A method of loosening ingrown bone from an intervertebral implant using an ultrasonic instrument having a self tapping connector. The method comprises surgically accessing the intervertebral implant. The intervertebral implant includes first and second endplate assemblies and the first endplate assembly includes an unthreaded aperture. The method further comprises tapping the unthreaded aperture of the first endplate assembly with the self-tapping connector and passing an ultrasonic energy through the self tapping connector to the first endplate assembly. The method also comprises ultrasonically vibrating the first endplate assembly to break a first portion of the ingrown bone from the intervertebral implant.

### BACKGROUND

In the treatment of diseases, injuries or malformations affecting spinal movement and disc tissue, it has long been common practice to remove a portion or all of a degenerated, ruptured, or otherwise failing disc. Following the loss or removal of disc or vertebral tissue, spinal implant devices have been implanted to promote fusion, restore motion to the treated area of the spine, or otherwise relieve pain in the spine. Occasionally after a spinal implant device has been installed and secured in the spine, revision procedures are required to modify or remove the device. Therefore, a method and apparatus are needed which allow safe and efficient removal of spinal implant devices.

### SUMMARY

This disclosure relates to a new apparatus and method for revising a spinal implant device. One embodiment describes a method of using an ultrasonic revision instrument to loosen ingrown bone from an implant disposed between a pair of vertebral bodies. The method comprises threading an end portion of the revision instrument to the implant and passing ultrasonic energy through the end portion of the revision instrument to the implant. The implant is ultrasonically vibrated to break down the ingrown bone.

Another embodiment describes an implant revision instrument for loosening a bony interface between an implant and bone. The instrument comprises an ultrasonic actuator and an implant engagement portion driven by the ultrasonic actuator and adapted for coupling to the implant. The ultrasonic actuator creates ultrasonic motion in the implant engagement portion causing deterioration of the bony interface and loosening of the implant.

### BRIEF DESCRIPTION OF THE DRAWINGS

FIG. 1 is a side view of vertebral column including a spinal implant device.

FIG. 2 is a perspective view of an ultrasonic revision tool and revisable implant according to one embodiment of the present invention.

FIGS. 3-8 are alternative embodiments of ultrasonic tool portions.

FIG. 9 is a side elevation of an ultrasonic revision tool according to another embodiment of the present invention.

FIG. 10 is an orthogonal view of the ultrasonic revision tool of FIG. 9.

### DETAILED DESCRIPTION

The present disclosure relates generally to the field of orthopedic surgery, and more particularly to the instrumentation and techniques for spinal implant revision procedures. For the purposes of promoting an understanding of the principles of the invention, reference will now be made to embodiments or examples illustrated in the drawings, and specific language will be used to describe the same. It will nevertheless be understood that no limitation of the scope of the invention is thereby intended. Any alteration and further modifications in the described embodiments, and any further applications of the principles of the invention as described herein are contemplated as would normally occur to one skilled in the art to which the invention relates.

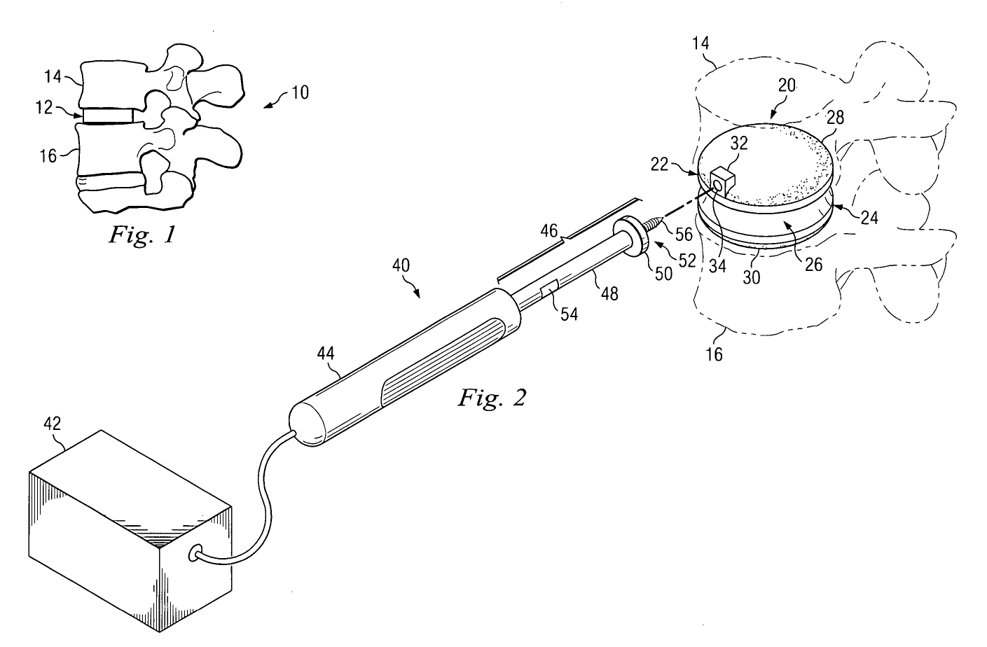

Referring to FIG. 1, the reference numeral 10 generally refers to a vertebral column with a spinal implant 12 extending between vertebral bodies 14, 16. In this embodiment, the spinal implant is an intervertebral implant, but it is understood that the methods and apparatus of the invention may be applied to other types of spinal implants including vertebral body and corpectomy implants. Fusion devices such as cages and plates may also be revised using the techniques described herein.

Referring to FIG. 2, in one embodiment a motion preserving implant 20 may be used as the spinal implant 12. The implant 20 includes endplate assemblies 22, 24 and a core component 26. The endplate assembly 22 may be movable with respect to endplate assembly 24 in at least one degree of freedom. The endplate assemblies 22, 24 include exterior surfaces 28, 30. The endplate assembly 22 may also include an instrument attachment portion 32 having an aperture 34. In the embodiment of FIG. 2, the aperture 34 may be an unthreaded through bore.

The endplate assemblies 22, 24 may be formed of any suitable biocompatible material including metals such as cobalt-chromium alloys, titanium alloys, nickel titanium alloys, and/or stainless steel alloys. Certain ceramic or polymer materials may also be suitable.

The exterior surfaces 28, 30 may include textures or coatings which enhance the fixation of the implanted prosthesis by promoting bone growth in and around the implanted prosthesis. For example, the surfaces may be roughened such as by chemical etching, bead-blasting, plasma spray porous coating, sanding, grinding, serrating, and/or diamond-cutting. All or a portion of the exterior surfaces 28, 30 may also or alternatively be coated with biocompatible osteoconductive materials such as hydroxyapatite (HA) or osteoinductive coatings such as bone-morphogenic proteins. Permanent or temporary adhesive materials may also be used to hold the implant 20 in place until bone growth has advanced to provide more stable fixation.

The implant 20 may be implanted between the vertebral bodies 14, 16, using an anterior, anterolateral, lateral, or other approach known to one skilled in the art. The implant 20 may become affixed to the vertebral bodies 14, 16 using the textures or coatings listed above. The speed of fixation to the vertebral bodies 14, 16 will vary depending upon the type of textures or coatings used and characteristics specific to each patient.

After the implant 20 becomes affixed, conditions may arise, such as additional spinal disease or injury, deterioration of the implant, migration of the implant, or improvements in technology, which require revision of the implant. An ultrasonic revision tool 40 may be used to loosen and/or remove the spinal implant 20. The tool 40 may be used in any area of the spine including the cervical area. The tool 40 may include a power supply device 42, a handpiece 44, and an ultrasonic tip portion 46. The power supply device 42 may include a variety of devices (not shown) including an ultrasonic generator, frequency adjustment controls, fluid delivery controls, and other devices which may allow the operator to control the ultrasonic revision tool 40. The handpiece 44 may include an actuator (not shown), such as a transducer, for converting electrical ultrasonic energy into mechanical ultrasonic vibratory motion having a frequency in the ultrasonic range, i.e. greater than 20 kilohertz. The ultrasonic tip portion 46 may include a shaft portion 48, a flange 50, and an engagement portion 52. The shaft portion 48 may include gripping areas 54. The gripping areas 54 may, for example, be milled flats or knurled areas on the shaft portion 48. The engagement portion 52 may include a self-tapping screw 56 and/or other mechanical connecters. The shape, size, and configuration of the components 42-56 are merely exemplary and any of a variety of alternative configurations may be desirable.

The components of the revision tool 40 may be made of durable, medically acceptable materials, such as stainless steel, hard coated anodized aluminum, or titanium, for example, capable of being sterilized to medical standards, such as by steam or flash autoclaving, gas sterilization, and/or soaking in a disinfectant solution. Accordingly, the revision tool 40 may or may not be designed for repeated use. In alternative embodiments, to promote efficiency and sterility, the ultrasonic tip portion 46 may be disposable.

For an anteriorly approached implant revision procedure, the implant 20 may have been positioned such that the instrument attachment portion 32 is located on the anterior side of the implant. During the revision procedure, the ultrasonic tip portion 46 may be held by the gripping areas 54 and the self-tapping screw 56 may tap through the aperture 34 of the instrument attachment portion 32. As the self-tapping screw 56 is threaded into the aperture 34, the flange 50 may be tightly drawn to attachment portion 32.

In operation, the power supply device 42 may provide a high frequency, low amplitude ultrasonic energy to handpiece 44 which may, in turn, supply ultrasonic vibratory motion to the ultrasonic tip portion 46. In some embodiments, the ultrasonic frequency may be 20 kilohertz or greater. While the tip portion 46 is moving with ultrasonic frequency, its actual displacement may be relatively small, for example less than a few millimeters. A tight connection between the flange 50 and the attachment portion 32 may serve to efficiently transfer ultrasonic vibratory motion from the revision tool 40 to the implant 20. The ultrasonic vibratory motion transferred from the tip portion 46 to the implant 20 may fragment the adjacent bone ingrowth and overgrowth, causing the implant 20 to break loose from the adjacent vertebral bodies 14, 16 with minimal trauma to surrounding bone or soft tissue. Because the implant 20 may be held in place by a combination of mechanical features (e.g., surface textures, tabs, anchors) and bone overgrowth and ingrowth, the ultrasonic motion may act upon the bone adjacent to the implant rather than on a cement mantle.

As the implant 20 begins to loosen, ultrasonic vibratory motion may be supplemented with larger movements of the ultrasonic tip portion 46 such as arc shaped motions, linear reciprocating motions, or random motions to further loosen the implant 20. The speed, force, and other characteristics of the movement of the ultrasonic tip portion 46 may be adjusted, for example, by varying the ultrasonic frequency or amplitude. The displacement of the ultrasonic tip portion 46 and the implant 20 caused by the ultrasonic vibratory motion may be less than a few millimeters, however larger or smaller displacements may be appropriate for certain applications.

The revision tool 40 may eliminate or reduce the need for sharp chisels, hammers, or other instruments which can potentially damage surrounding tissue and/or severely injure the patient. As described, the tool 40 may break up hard tissue in the area of application, but may have a relatively benign impact on surrounding soft tissue. Bone ingrowth and overgrowth can obscure the size and shape of the implant. In this environment, the disclosed tool 40 may minimize the damage caused to the vertebral bodies by targeting the bone removal to the areas most proximate to the implant without requiring a clear view of the implant. The use of ultrasonic vibration to remove or relocate an implant may also promote the long term stability of a repositioned or replacement implant because the bone particles released by the vibration may be redeposited in the area of the implant to stimulate subsequent bone ingrowth around a subsequent implant.

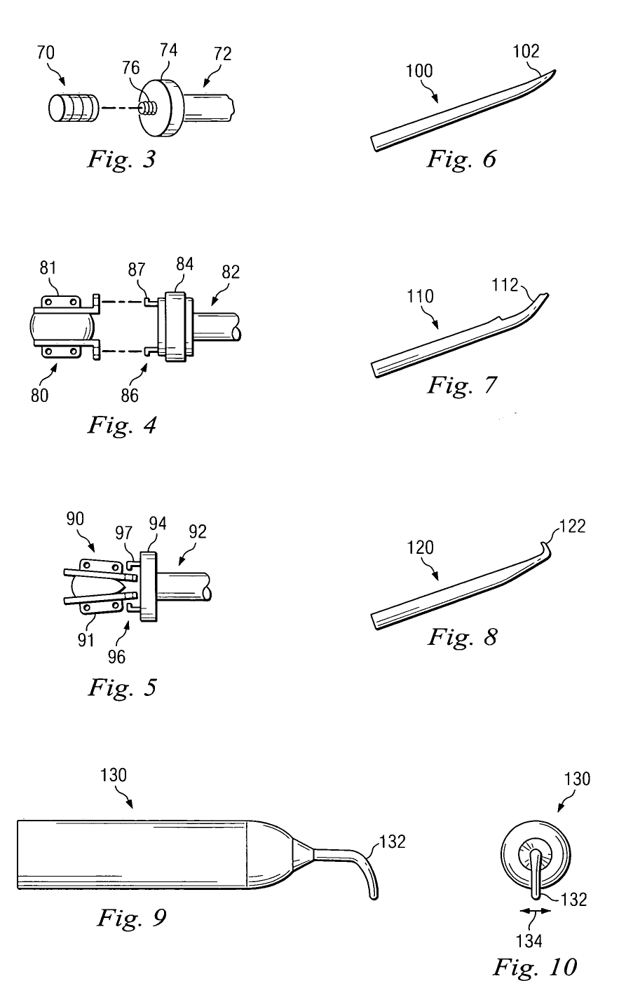

Referring now to FIGS. 3-5, alternative embodiments of ultrasonic tip portions may be configured for attachment to various vertebral implants. As shown in FIG. 3, a cylindrical implant 70 may, for example, be a intervertebral fusion implant secured to adjacent bone by a combination of external threads and bone ingrowth. An ultrasonic tip portion 72 may be substantially similar to tip portion 46 except as described below. The tip portion 72 may include a flange 74 and an engagement portion 76. The engagement portion 52 may be threaded to engage corresponding threads on the implant 70. With the engagement portion 76 threaded to the implant 70, ultrasonic vibratory motion may be passed from the tip portion 72 through the implant 70. The ultrasonic motion of the implant 70 may cause the surrounding bone to break up and loosen. The implant 70 may be further loosened by providing a torque or linear motion to the tip portion 72 while the implant is ultrasonically agitated.

Referring now to FIG. 4, an implant 80 may, for example, be an intervertebral implant secured to adjacent bone by a combination of external anchors 81 and bone ingrowth. An ultrasonic tip portion 82 may be substantially similar to tip portion 46 except as described below. The tip portion 82 may include a flange 84 and an engagement portion 86. The engagement portion 86 may include hooks 87 to engage corresponding openings on the implant 80. With the engagement portion 86 hooked to the implant 80, ultrasonic vibratory motion may be passed from the tip portion 82 through the implant 80. The ultrasonic motion of the implant 80 may cause the surrounding bone to granulate and loosen. The implant 80 may be further loosened by providing an arced or linear motion to the tip portion 82 while the implant is ultrasonically agitated.

Referring now to FIG. 5, an implant 90 may, for example, be an intervertebral implant secured to adjacent bone by a combination of external anchors 91 and bone ingrowth. An ultrasonic tip portion 92 may be substantially similar to tip portion 46 except as described below. The tip portion 92 may include a flange 94 and an engagement portion 96. The engagement portion 96 may include clamps 97 to engage corresponding openings on the implant 90. With the engagement portion 96 clamped to the implant 90, ultrasonic vibratory motion may be passed from the tip portion 92 through the implant 90. The ultrasonic motion of the implant 90 may cause the surrounding bone to deteriorate and loosen. The implant 90 may be further loosened by providing an arced or linear motion to the tip portion 92 while the implant is ultrasonically agitated.

Referring now to FIGS. 6-8, alternative embodiments of an ultrasonic revision tool may be configured to locate the engagement portion of the ultrasonic tip portion at or near the margin of the bone/ implant interface rather than coupling directly to the implant. Ultrasonic tip portions 100, 110, 120 include engagement portions 102, 112, 122, respectively. The engagement portions may be straight (FIG. 6), curved (FIG. 7), or hooked (FIG. 8) to provide versatility in accessing and applying ultrasonic energy to the bone/implant interface. The engagement portions may be osteotomes, files, or other types of sculpting and separating instruments. Referring, for example, to FIG. 6, the engagement portion 102 which is a relatively straight osteotome, may be positioned at the interface of the implant 12 and the vertebral body 14. Ultrasonic vibratory motion may be passed through the tip portion 100 causing the bone surrounding the implant 12 to crumble or break loose.

Referring now to FIGS. 9-10, an ultrasonic revision tool 130 may be substantially similar to tool 40 except for the differences described below. The tool 130 may include a curved engagement portion 132 that moves in a generally linear reciprocating path 134 when excited by ultrasonic energy. This ultrasonic motion may be applied to the interface of the implant 12 and the vertebral body, causing the bone surrounding the implant to separate. The tool 130 may also be used to separate and remove unwanted bony deposits that develop on the implant 12.

In alternative embodiments, the ultrasonic revision tools 40, 130 may further include a fluid delivery system that applies a fluid such as water to the area of the engagement portion as the implant is loosened. This lavage may act as a coolant, a lubricant, and/or a cleansing agent.

Ultrasonic revision tools such as those described in this disclosure may also be used to remove implants in other areas of the body. The disclosed invention may be useful in many applications in which bone ingrowth or overgrowth has occurred in the area of an implant.

Although an electrically powered revision instrument has been disclosed above, it is understood that alternative power devices may be selected including pneumatic, battery, or gas powered devices. These alternative power devices may be supported by additional or alternative components. Also the components of the power supply device may be integrally formed with the handpiece.

The present disclosure provides a method of loosening ingrown bone from an intervertebral implant using an ultrasonic instrument having a self tapping connector. The method comprises surgically accessing the intervertebral implant. The intervertebral implant includes first and second endplate assemblies and the first endplate assembly includes an unthreaded aperture. The method further comprises tapping the unthreaded aperture of the first endplate assembly with the self-tapping connector and passing an ultrasonic energy through the self tapping connector to the first endplate assembly. The method also comprises ultrasonically vibrating the first endplate assembly to break a first portion of the ingrown bone from the intervertebral implant.

Another embodiment of this disclosure provides a method of separating a vertebral implant from a pair of adjacent vertebral bodies. The method comprising ultrasonically agitating a revision instrument, ultrasonically agitating the adjacent vertebral bodies, breaking up a layer of bone ingrowth extending between the vertebral bodies and the vertebral implant, and separating the vertebral implant from the adjacent bone.

Another embodiment of this disclosure provides a revisable intervertebral implant comprising an exterior surface adapted for promoting adhesion to bone and an instrument coupling portion including an unthreaded aperture adapted for receiving a self-tapping ultrasonic revision instrument. An ultrasonic vibration received from the ultrasonic revision instrument through the instrument coupling portion loosens the adhesion between the exterior surface and the bone.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications and alternative are intended to be included within the scope of this invention as defined in the following claims. Those skilled in the art should also realize that such modifications and equivalent constructions or methods do not depart from the spirit and scope of the present disclosure, and that they may make various changes, substitutions, and alterations herein without departing from the spirit and scope of the present disclosure. It is understood that all spatial references, such as “horizontal,” “vertical,” “top,” “upper,” “lower,” “bottom,” “left,” and “right,” are for illustrative purposes only and can be varied within the scope of the disclosure. In the claims, means-plus-function clauses are intended to cover the structures described herein as performing the recited function and not only structural equivalents, but also equivalent structures.

What is claimed is:

1. A method of loosening ingrown bone from an intervertebral implant using an ultrasonic instrument having a self tapping connector, the method comprising:
surgically accessing the intervertebral implant, wherein the intervertebral implant includes first and second endplate assemblies, and wherein the first endplate assembly includes an unthreaded aperture;
tapping the unthreaded aperture of the first endplate assembly with the self-tapping connector;
passing an ultrasonic energy through the self tapping connector to the first endplate assembly; and
ultrasonically vibrating the first endplate assembly to break a first portion of the ingrown bone from the intervertebral implant.

2. The method of claim 1 further comprising:
passing the ultrasonic energy through first endplate assembly to the second endplate assembly, wherein the first endplate assembly is movable with respect to the second endplate assembly in at least one degree of freedom.

3. The method of claim 1 wherein the second endplate assembly includes an unthreaded aperture, the method further comprising:
tapping the unthreaded aperture of the second endplate assembly with the self-tapping connector;
passing the ultrasonic energy through the self tapping connector to the second endplate assembly;
ultrasonically vibrating the second vertebral assembly to break a second portion of the ingrown bone from the intervertebral implant.

4. The method of claim 1 wherein the ultrasonic energy has a frequency of at least 30 kilohertz.

5. The method of claim 1 wherein surgically accessing the intervertebral implant includes surgically accessing an anterior portion of the intervertebral implant.

6. The method of claim 1 further comprising:
removing the intervertebral implant from between a pair of vertebral bodies.

7. The method of claim 1 wherein the intervertebral implant is an intervertebral motion preserving disc replacement.

8. The method of claim 1 wherein the intervertebral implant is a fusion implant.

9. A method of separating a vertebral implant from a pair of adjacent vertebral bodies, the method comprising:
ultrasonically agitating a revision instrument;
ultrasonically agitating the adjacent vertebral bodies;
breaking up a layer of bone ingrowth extending between the vertebral bodies and the vertebral implant; and
separating the vertebral implant from the adjacent bone.

10. The method of claim 9 further comprising:
coupling the revision instrument to an endplate assembly of the vertebral implant; and
introducing an ultrasonic vibratory motion from the revision instrument to the vertebral implant.

11. The method of claim 10 wherein the revision instrument is coupled to a cobalt-chromium alloy endplate assembly of the vertebral implant.

12. The method of claim 10 wherein the revision instrument is coupled to a titanium alloy endplate assembly of the vertebral implant.

13. The method of claim 10 wherein the revision instrument is coupled to a stainless steel alloy endplate assembly of the vertebral implant.

14. The method of claim 10 wherein coupling the revision instrument to the vertebral implant includes self-tapping the revision instrument to an unthreaded through bore in the endplate assembly of the vertebral implant.

15. The method of claim 10 wherein coupling the revision instrument to the vertebral implant includes hooking the revision instrument to the endplate assembly of the vertebral implant.

16. The method of claim 10 wherein coupling the revision instrument to the vertebral implant includes clamping the revision instrument to the endplate assembly of the vertebral implant.

17. The method of claim 9 further comprising:
locating an interface between the vertebral implant and the adjacent vertebral bodies;
positioning the revision instrument at the interface between the vertebral implant and the adjacent vertebral bodies; and
introducing an ultrasonic vibratory motion to the interface to break up the layer of bone ingrowth.

18. The method of claim 17 wherein the revision instrument includes a straight osteotome.

19. The method of claim 17 wherein the revision instrument includes a curved osteotome.

20. The method of claim 17 wherein the revision instrument includes a file.

21. The method of claim 9 further comprising projecting a lavage fluid from the revision instrument.

22. An implant revision instrument for loosening a bony interface between a vertebral implant and an adjacent vertebral body, the instrument comprising:
an ultrasonic actuator;
an implant engagement portion driven by the ultrasonic actuator and adapted for self-tapping an unthreaded aperture in the vertebral implant,
wherein the ultrasonic actuator creates ultrasonic motion in the implant engagement portion for deteriorating the bony interface and loosening of the vertebral implant.

23. The implant revision instrument of claim 22 wherein the ultrasonic actuator is a transducer.

24. The implant revision instrument of claim 22 further comprising a power supply device for powering the ultrasonic actuator.

25. A revisable intervertebral implant comprising:
an exterior surface adapted for promoting adhesion to bone and
an instrument coupling portion including an unthreaded aperture adapted for receiving a self-tapping ultrasonic revision instrument,
wherein an ultrasonic vibration received from the ultrasonic revision instrument through the instrument coupling portion loosens the adhesion between the exterior surface and the bone.

26. The revisable intervertebral implant of claim 25 wherein the exterior surface includes a roughened surface texture for promoting bone ingrowth.

27. The revisable intervertebral implant of claim 25 wherein the exterior surface includes a smooth surface.

28. The revisable intervertebral implant of claim 25 wherein the exterior surface is coated with osteoconductive or osteoinductive material.

29. The revisable intervertebral implant of claim 25 wherein the instrument coupling portion is formed from a cobalt-chromium alloy.

30. The revisable intervertebral implant of claim 25 wherein the instrument coupling portion is formed from a titanium alloy.

31. The revisable intervertebral implant of claim 25 wherein the instrument coupling portion is formed from a stainless steel alloy.
